(19) United States
(12) Patent Application Publication
(10) Pub. No.: US 2012/0246195 A1
(43) Pub. Date: Sep. 27, 2012

(54) LOCATING SYSTEM AND A METHOD FOR OPERATING A LOCATING SYSTEM

(75) Inventors: Peter Mcfall, Cape Town (ZA); Warren Venter, Stellenbosch (ZA)

(73) Assignee: Waytag (Proprietary) Limited, Stellenbosch (ZA)

(21) Appl. No.: 13/501,392

(22) PCT Filed: Oct. 12, 2010
(86) PCT No.: PCT/IB2010/054611

§ 371 Date: Jun. 15, 2012

(30) Foreign Application Priority Data
Oct. 12, 2009 (ZA) 2009/07092

(51) Int. Cl. G06F 17/30

(52) U.S. Cl. 707/770; 707/E17.014

(57) ABSTRACT

A location system for locating an entity, and a method of operating such a system, are disclosed. The method includes receiving identification information associated with at least one entity such as a person or business. A unique identifier associated with the at least one entity is either generated by the system or provided by a user of the system. The system receives geographic location data associated with the entity. The received identification information, the received geographic location data and the unique identifier associated with the at least one entity are stored in an updatable database. The unique identifier is usable to access the updatable database to retrieve the identification information and geographic location data associated with the entity. The location system includes an identification receiver module which receives identification information associated with the entity. A location receiver module is arranged to receive geographic location data associated with the entity. An updatable database is arranged to store the received identification information and the received geographic location data associated with the entity. An association module is arranged to associate the generated or user-provided unique identifier with the entity.

### BACKGROUND OF THE INVENTION

THIS invention relates to a location system for locating entities and to a method of operating a location system.

Conventional location methods and/or systems used to locate a particular entity (a person, business, organization, post box, delivery address, club, place of interest, parking bay or the like) generally provide a user with a street address of the particular entity. This is often the case, for example, with telephone directories, or similar directories. It will be appreciated that this often proves less than adequate to locate the desired entity.

It is therefore an object of the present invention at least to address the abovementioned problem.

### SUMMARY OF THE INVENTION

According to a first aspect of the invention there is provided a method of operating a location system for locating an entity, the method including:
receiving identification information associated with at least one entity;
providing a unique identifier associated with the at least one entity;
receiving geographic location data associated with the at least one entity; and
storing the received identification information, the received geographic location data and the unique identifier associated with the at least one entity in an updatable database, the unique identifier being usable to access the updatable database to retrieve the identification information and geographic location data associated with the at least one entity therefrom.

The method may comprise receiving and storing identification data and geographic location data from a plurality of entities.

The entities may comprise people, businesses, organisations, or the like.

In a preferred example embodiment, the geographic location data may comprise a waypoint, which may comprise longitude and latitude co-ordinates, altitude and time, satellite positioning co-ordinates, Global Navigation Satellite Systems (GNSS) co-ordinates, GPS (Global Positioning System), co-ordinates, or the like associated with the entity.

The unique identifier may comprise a number or numeric value, a character string, an alphanumeric code, or a combination thereof.

The method may comprise generating the unique identifier automatically.

Instead, or in addition, the method may comprise receiving a selected unique identifier from a user of the location system.

The method may include a step of registering the entity with the location system.

The method may include the steps of:
receiving a unique identifier associated with a particular entity from a user;
accessing the database and retrieving stored identification information and geographic location data associated with a particular entity from the database using at least the received unique identifier; and
presenting the retrieved identification information and geographic location data to the user.

According to a second aspect of the invention there is provided a location system for locating an entity, the location system including:
an identification receiver module arranged to receive identification information associated with at least one entity;
a location receiver module arranged to receive geographic location data associated with the at least one entity,
an updatable database arranged to store the received identification information and the received geographic location data associated with the at least one entity; and
an association module arranged to associate a unique identifier with the at least one entity, the unique identifier being arranged to access the updatable database to retrieve the identification information and geographic location data associated with the at least one entity therefrom.

The location system may include a registration module for registering the at least one entity with the location system.

The location system preferably includes a search module arranged, in response to receiving a unique identifier associated with a particular entity from a user, to access the database and retrieve stored identification information and geographic location data associated with a particular entity from the database using at least the received unique identifier, for display to the user.

The location system may include a user interface supported by a web server and accessible via computing devices of users of the system to facilitate registration, receiving and storing identification data and geographic location data, updating of said identification data and geographic location data, and searching by said users.

Preferably, the updatable database is arranged to permit the identification information and the geographic location data associated with an entity to be changed without necessarily changing the respective unique identifier associated with the entity, so that the entity may maintain the unique identifier irrespective of changes in its physical location or other identification information.

### BRIEF DESCRIPTION OF THE DRAWINGS

FIG. 1 Is a simplified schematic diagram of major components of a location system in accordance with an example embodiment of the invention;

FIG. 2 is a simplified schematic drawing of major hardware and software modules of the system of FIG. 1 in greater detail;

FIG. 3 is a flow diagram of a first aspect of a method in accordance with an example embodiment;

FIG. 4 is a flow diagram of a second aspect of a method in accordance with an example embodiment;

FIG. 5 is a flowchart of a sign-up process forming part of the method;

FIG. 6 is a flowchart of a process for adding or editing a record forming part of the method;

FIG. 7 is a flowchart of a process for viewing a list of records forming part of the method;

FIG. 8 is a flowchart of a process for viewing and managing a list of favourite records forming part of the method;

FIG. 9 is a flowchart showing a process for viewing records via a web interface forming part of the method;

FIG. 10 is a flowchart showing a process for updating records and adding journal entries forming part of the method;

FIG. 11 is a flowchart showing a process of obtaining navigation instructions forming part of the method;

FIG. 12 is a flowchart showing a business search process forming part of the method;

FIG. 13 shows a sample screenshot of a webpage for registering an individual with the system of FIGS. 1 and 2 in accordance with an example embodiment; and

FIG. 14 shows a sample screenshot of a webpage for registering a business with the system of FIGS. 1 and 2 in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

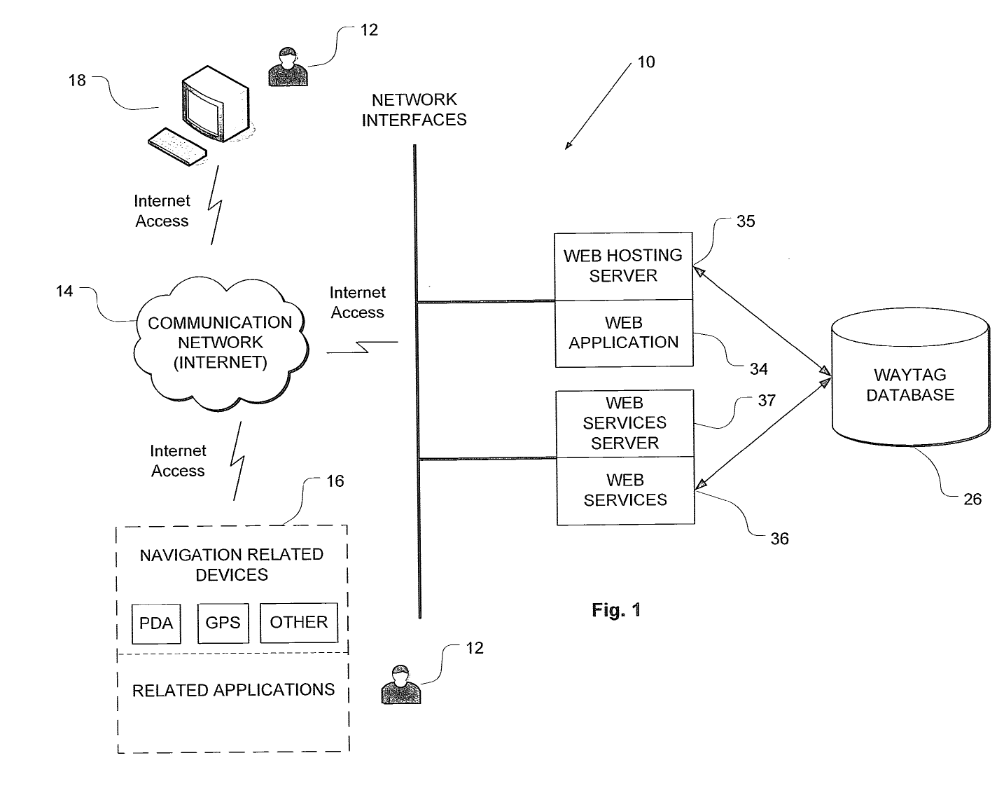

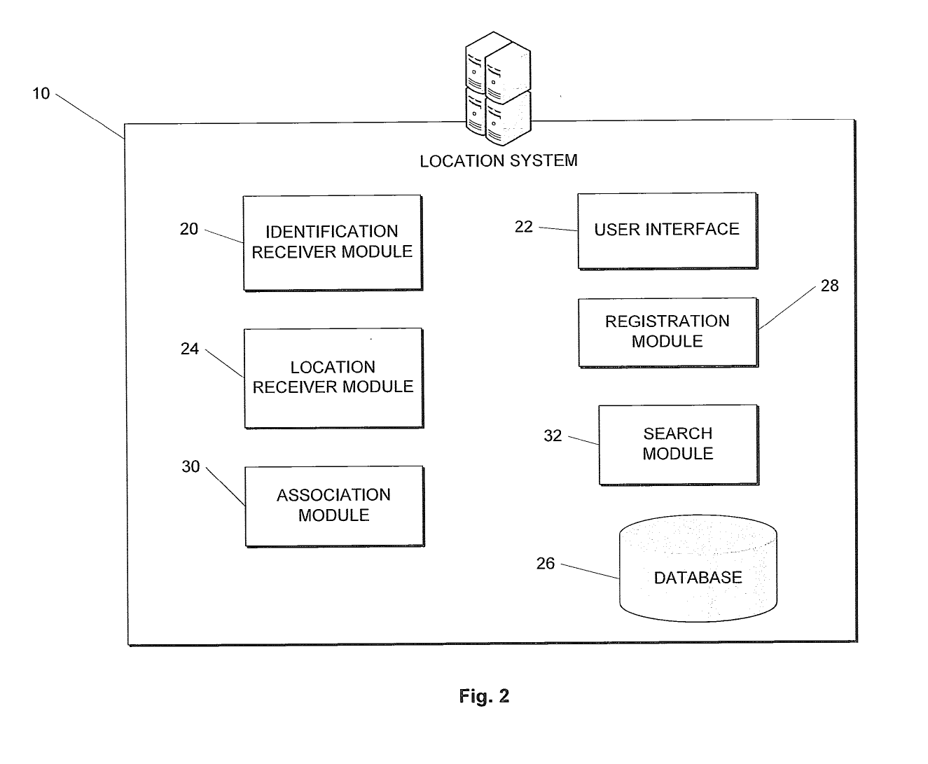

Referring to FIGS. 1 and 2 of the drawings, a location system in accordance with an example embodiment of the invention is generally indicated by the reference numeral 10. The location system 10 can be used for locating entities such as natural persons; legal persons such as businesses, organisations, clubs, societies; Government departments; objects or landmarks, or the like. The system 10 is conveniently accessible by a user 12 over a communication network 14 by way of a first communication or computing device 16, and also via a second communication or computing device 18.

The communication network 14 may be a packet-switched network and may be, or form part of, the Internet. Instead, the communications network 14 may be a circuit switched network, public switched data network, or the like. In other example embodiments, the communication network 14 is a telecommunication network, for example, a wireless or cellular telecommunication network, a public switched telephone network (PSTN), or the like.

The first communication or computing device 16 may be a PC (Personal Computer), or a mobile communication/computing device such as a laptop computer, cellular telephone, smart-phone, personal digital assistant (PDA), GPS receiver or the like, adapted to communicate with the location system 10 over the communication network 14. It will appreciated that the list of devices 16 is intended to be exemplary and not limiting. Conveniently, the device 16 may be a mobile or portable device.

In a preferred example embodiment, the system 10 is accessible via a webpage or website. It follows that the system 10 may also be accessible via a mobile website or webpage.

The second communication or computing device 18 may be the same as the device 16, but will typically be a computer such as a PC or laptop computer used by the user 12 to access the World Wide Web, and need not be a mobile or portable device.

The device 18 is generally used by the user 12 to register with the location system and to conduct maintenance operations, whereas the device 16 is generally used on a day to day basis by the user 12 to access the location system and to make use of the system's functionality. However, it will be appreciated that both functions could be served by either device, particularly by the mobile device 16.

The system 10 may comprise a plurality of components or modules which correspond to the functional tasks to be performed by the system. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices in the system 10.

In particular, the system 10 comprises an identification receiver module 20 arranged to receive identification information associated with at least one entity. The received identification information associated with the at least one entity may be the name of the entity, contact details of the entity, for example, facsimile or telephone numbers, post box details, delivery addresses, clubs, place of interest, parking bays, or a business category of the entity if applicable. The identification information may also optionally comprise a description of the entity, a logo associated with the entity, or any other information associated with the entity which may be useful to the user. The identification receiver module 20 may be arranged to receive identification information from the entity via a user interface 22, particularly via a website which provides the user interface 22 (see below).

The system 10 also comprises a location receiver module 24 arranged to receive geographic location data associated with the entity. It will be appreciated that the geographic location data may conveniently comprise waypoints to the entity. The waypoints typically comprise longitude and latitude co-ordinates to locate the entity, although they may also include altitude and time. In particular, the module 24 is arranged to receive waypoints which comprise satellite positioning co-ordinates, Global Navigation Satellite Systems (GNSS) co-ordinates, UTM (Universal Transverse Mercator) co-ordinates, WAAS (Wide Area Augmentation System) co-ordinates, GPS (Global Positioning System) co-ordinates, or the like to locate the entity. It is also possible that the waypoints can be based on triangulation using data from cellular network transmitters or base stations, or related to the known physical location of network cells, transmitters or hotspots, for example. The waypoints may also comprise a physical address, a postal address, a delivery address, a place of interest associated with the entity, or the like.

The system 10 also comprises an updatable database 26 arranged to store the received identification information and the received geographic location data from the identification receiver module 20 and the location receiver module 24 respectively.

The system 10 includes a registration module 28 arranged to register entities to the system 10. The registration module 28 may be arranged to prompt the entity, via the website, for identification information and geographic location data. It will be appreciated that the entities registered to the system 10 may have their identification information and geographic location data stored in the database 26. It follows that the information stored in the database 26 may be updated should any of the details of a particular entity change.

Also, the registration module 28 may be arranged to register users to use the system 10 (as discussed below).

The system 10 also comprises an association module 30 arranged to associate a unique identifier with the at least one entity, the unique identifier being usable to access the database 26 to retrieve the identification information and geographic location data associated with the at least one entity therefrom.

The unique identifier may be generated by the association module 30. Instead, or in addition, the unique identifier may be provided by the entity, or selected from a number of options generated by the system. In the case where the entity is not a natural person, the person/s responsible for registering the entity to the system 10 may provide or select the unique identifier.

The unique identifier may comprise a number or numeric value, a character string or an alphanumeric code, or a combination of these, for example.

The system 10 also includes a search module 32 arranged to receive a unique identifier associated with an entity from a user. The module 32 is arranged to access the database 26 to retrieve stored identification information and geographic location data associated with the entity from the database 26 using at least the received unique identifier. It will be appreciated that, in other example embodiments, the system 10 may be arranged to return information associated with other entities associated with unique identifiers in a particular geographical area if desired.

The search module 32 may also be arranged to present the retrieved identification information and geographic location data to the user by way of the user interface 22. The search module 32 may also be arranged to generate a map identifying the location of the entity thereon.

Referring again to FIG. 1, the user interface 22 will typically be provided by a web application 34 running on a web hosting server 35. The web server also supports the identification receiver module 20, the location receiver module 24, the registration module 28 and the association module 30. The search module 32 will typically be provided by a web services application 36 running on a web services server 37.

Each server comprises one or more processors, memory, hard disk storage for the database 26, and one or more network interface devices. The server hardware may be hosted by an ISP (Internet Service Provider), a cloud computing services provider or any similar provider. The system will preferably include a combination of local area network interfaces and fibre links to facilitate high speed data transfer between the hardware components of the system.

The web application 34 allows users 12 to access data relating to unique identifiers which is stored on the database 26, and to maintain their own unique identifiers and associated information stored in the database 26.

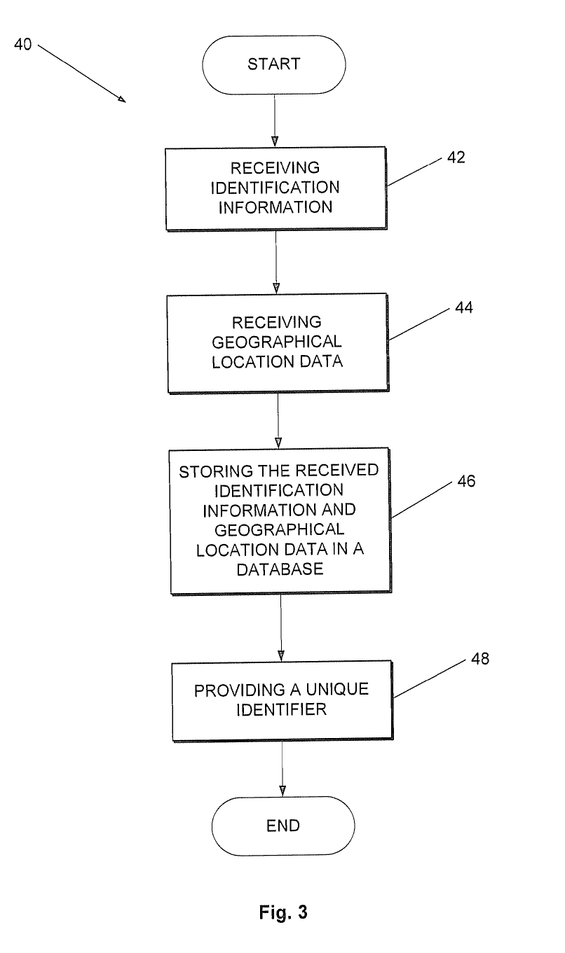

Example embodiments of the invention will now be further described with reference to FIGS. 3 to 14. The example methods shown in the flowcharts of FIGS. 3 to 12 are described with reference to the location system shown in FIGS. 1 and 2, although it is to be appreciated that the example methods may be applicable to other systems (not illustrated) as well.

Referring to FIG. 3 of the drawings, a flow diagram showing major steps of a method of operating a location system (for example the system 10) is generally indicated by reference numeral 40.

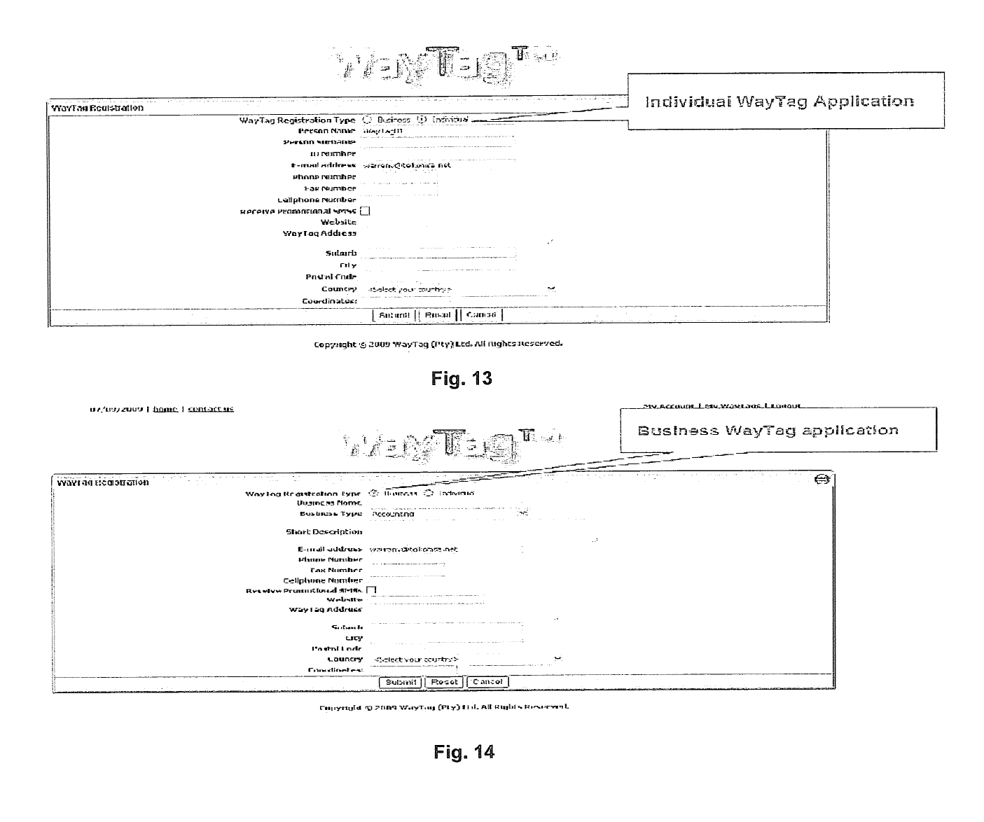

The method 40 comprises prompting an entity to register with the system 10 via a registration module 28. This may be done the first time that the entity uses the system 10. It will be appreciated that registration may be done via a webpage as illustrated in the screen shots of FIG. 13 or FIG. 14, depending on whether the entity is a natural person, legal person, landmark, or the like as hereinbefore described, respectively. It will be appreciated that in one example embodiment, only a registered entity may have their details accessible via the system 10. Also, it will be noted that not all information received from the entity during registration will necessarily be made available via the system 10. The flowchart of FIG. 5 illustrates the steps of the registration or sign-up process in greater detail.

In any event, for ease of explanation we will refer to a Company X which desires to register with the system 10. It will be appreciated that at least one member of Company X will be registering Company X with the system 10.

The method 40 then comprises receiving identification information, at block 42, associated with Company X by way of the identification receiver module 20. This identification information may comprise the business name, business type, a short description of the business, e-mail addresses associated with the business, telephone numbers, facsimile numbers, website addresses, searchable keywords, graphics and images, or the like. For individuals, the method may include receiving identity numbers or other personal identification information of the individual.

The method 40 further comprises receiving geographic location data, at block 44, associated with Company X by way of the location receiver module 24. The geographic location data preferably comprises information indicative of the country, suburb, and city in which Company X is physically located, for example the offices or principle place of business of Company X, parking bay, delivery address, postal address of Company X, or the like. In a preferred example embodiment, the geographic location data comprises a waypoint to the location of Company X, the waypoint preferably being GPS co-ordinates to the location of Company X. However, as previously mentioned, the waypoints may comprise any satellite locating co-ordinates, or alternative waypoints as discussed above.

The method 40 then comprises storing, at block 46, the received identification information and the received geographic location data associated with the at least one entity in the updatable database 26. The database 26 advantageously provides a repository for identification information associated with Company X as well as waypoints to locate Company X more easily, as will be discussed further below. The identification information and geographic location data may form part of a profile of the Company X in the system 10.

The method 40 may comprise confirming the received identification information and geographic location data with Company X before storing it in the database 26.

The method 40 will in practice comprise receiving and storing identification data and geographic location data from a plurality of entities.

The method 40 also comprises providing a unique identifier, at block 48, to Company X by way of the association module 30 as hereinbefore described. The method 40 may comprise receiving a unique identifier from Company X, for example, “CompX”. The method 40 therefore conveniently provides for an entity to personalise their unique identifier/s.

Several unique identifier owners may share a location but each owner is allocated or may customize their own unique identifier.

A registration or sign-up process, by which an entity signs up or registers with the location system, is shown in FIG. 5. Once already registered, entities can update their details and/or add more office locations, delete information etc. in different areas by logging in to the system and following applicable procedures provided. Updating, changing, or deleting information in the database 26 may be done in real-time, thereby conveniently eliminating tedious and costly address change notifications.

Importantly, the updatable database is arranged to permit the identification information and the geographic location data associated with an entity to be changed without necessarily changing the respective unique identifier associated with the entity, so that the entity may maintain the unique identifier irrespective of changes in its physical location or other identification information. This allows an entity to keep their unique identifier or Waytag indefinitely (“for life”) notwithstanding a change in their physical location or identification details.

Once registered, Company X may register several unique identifiers under its registration details, and may receive and store geographic location data relating to each person, entity, place or object occupying the location associated with the unique identifiers. This may be, for example, when Company X has a unique identifier for at least some of its members and has identification information and geographic location data associated with those members also stored in the database 26.

Also once registered, Company X may advantageously be provided with a login name and password. A customized login name may be requested by Company X.

When logged into the system 10, the system 10 may be arranged to indicate if a particular unique identifier status to be reflected is active or suspended.

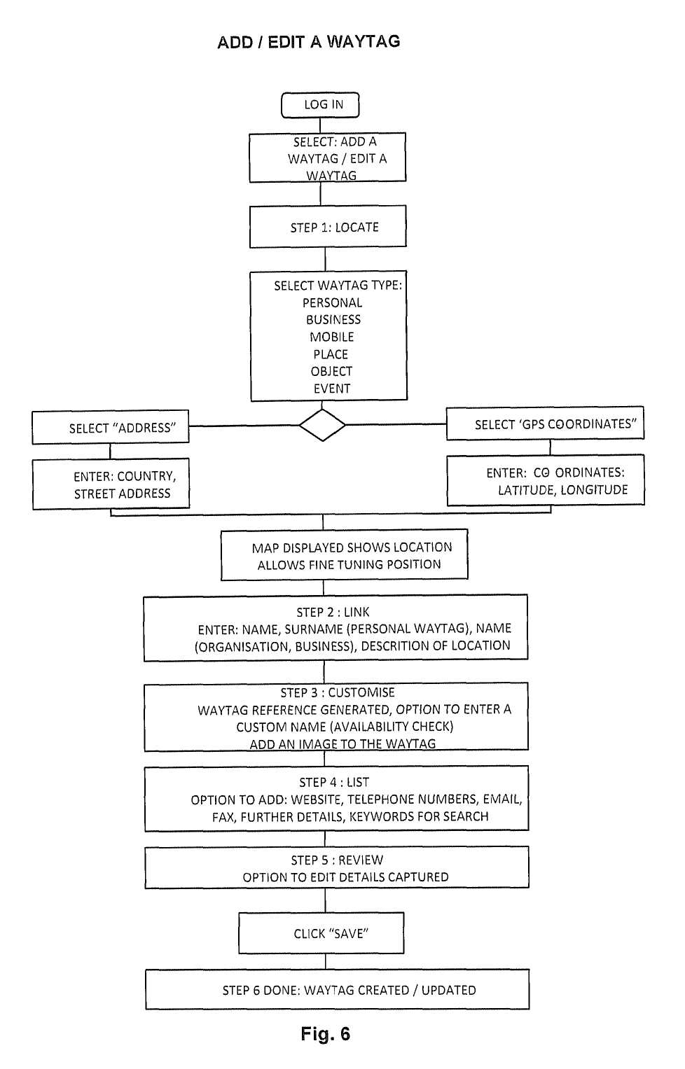

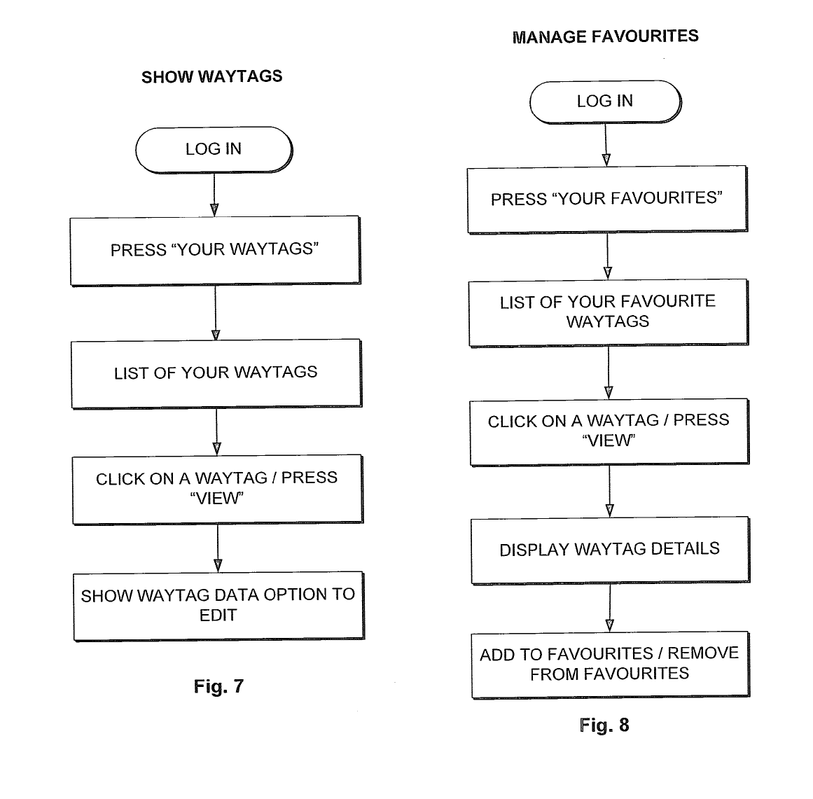

The process of registering a unique identifier, referred to in the particular example embodiment as a “Waytag”, is shown in more detail in the flowchart of FIG. 6, which is largely self explanatory. The flowchart of FIG. 7 shows the steps involved in a user logging in to view their previously registered unique identifiers or Waytags.

The unique identifier or Waytag consists of the following information:
a. An internationally unique code (Waytag). This code may be either system generated or entered by the user 12 as long as it is not already in use.
b. The type of Waytag, i.e. business, personal, object, place, event or mobile.
c. First name & surname or business name depending on the type of Waytag.
d. The physical address associated with the Waytag.
e. The co-ordinates (Latitude/Longitude/Altitude/Time) of the Waytag location.
f. A short description to describe the Waytag e.g. “Bob's home”, “Bob's currently here”.
g. An optional photograph of the location, individual, business, object, etc., related to the Waytag.
h. Optional contact information including: website, e-mail, fax, and telephone details.
i. Optional description of the business, event, place, or object which may include general information about the Waytag.
j. Location information.
k. Keywords which are relevant to the Waytag.

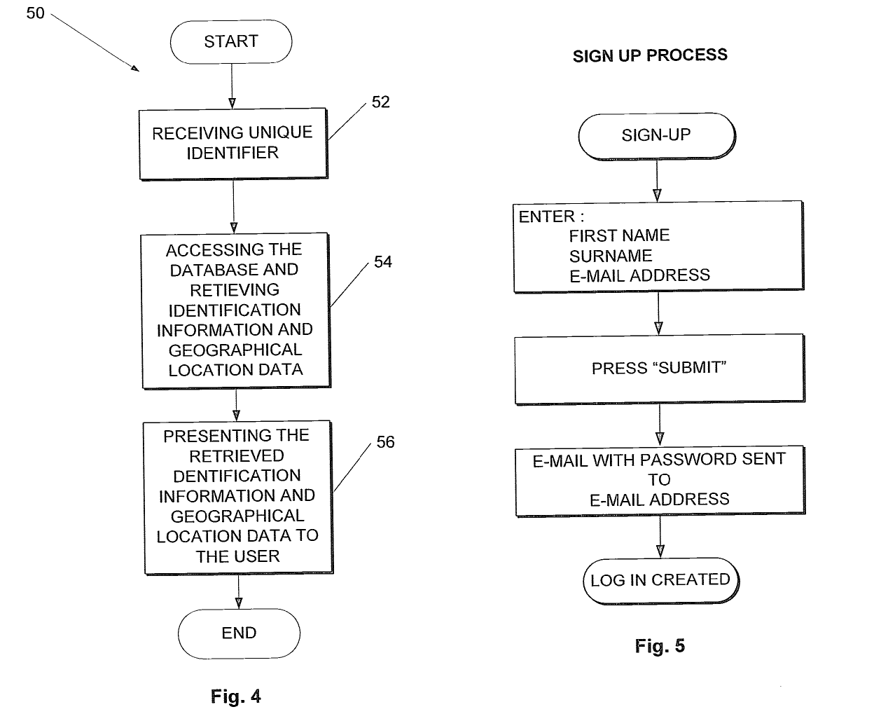

Referring now to FIG. 4 of the drawings, another aspect of the method in accordance with an example embodiment, relating to the retrieval of information from the location system, is generally indicated by reference numeral 50.

When a user wants to obtain information about Company X for example, they would enter the unique identifier of Company X over the communications network 14 via their computing device 16 or 18 (via the search module 32 which conveniently comprises a search engine). Login names and passwords for entities will be authenticated should an entity want to update, delete or add information, etc, to their profile.

It will be understood that the system 10 (and the search module 32 in particular) is available to any person via the web, or conveniently via a GPS device, without the need to register to the system 10.

In any event, the method 50 comprises receiving, at block 52, a unique identifier or Waytag associated with Company X from a user. In this particular example embodiment the unique identifier is a personalised identifier “CompX” as hereinbefore mentioned.

The method 50 further comprises accessing the database 26 and retrieving, at block 54, stored identification information and geographic location data associated with Company X from the database 26 using at least the received unique identifier “CompX”.

The method 50 also conveniently comprises presenting, at block 56, the retrieved identification information and geographic location data associated with Company X to the user via the user's computing device 16 or 18. As mentioned above, the computing device 16 may be a portable device and the retrieved information can therefore be used by a user who is travelling and who is looking for the physical location corresponding to a particular unique identifier or Waytag.

The search method as illustrated in FIG. 4 and hereinbefore described is advantageously performed by way of the search module 32 as hereinbefore described.

The system 10 may be arranged to allow the retrieved identification information and geographic location data to be e-mailed or sent via SMS (Short Message Service) to another location, device, communication network or party. Instead, the retrieved data can be sent by the web services application 36 to one of the related applications associated with the device 16.

It will be noted that the system 10 may advantageously be arranged to transmit geographic location details, typically GPS co-ordinates of the location of Company X, to a mobile computing device thereof equipped with navigation means. For example, the GPS co-ordinates may be transmitted to a GPS navigation enabled mobile cellular telephone or other personal navigation device (PND) of the user.

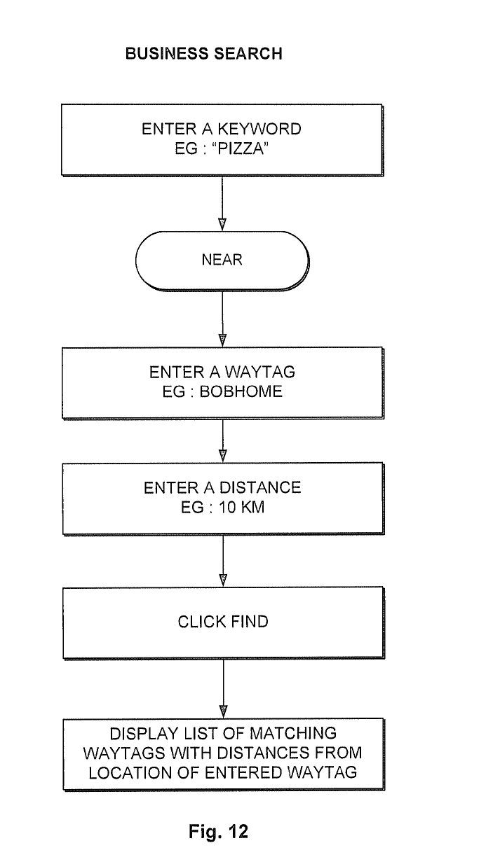

Instead of, or in addition to using the unique identifier or Waytag to conduct a search, the user may search for businesses of a particular type, or in a particular location, etc. For example, as indicated in the flowchart of FIG. 12, a user can enter a keyword such as “Pizza” and a selected unique identifier or Waytag, to find businesses near the physical location of the selected unique identifier within a specified range. The system then searches for entries in the database meeting the specified criteria and displays them.

A number of additional features of the system are illustrated in FIGS. 8 to 11.

The flowchart of FIG. 8 shows the steps involved in a user logging in to view or manage their previously selected or added unique identifiers or Waytags.

Favourite or regularly accessed Waytags are stored in “Your Favourites” for reasons of convenience, quick access, regular usage or sharing and other management processes required by the user from time to time.

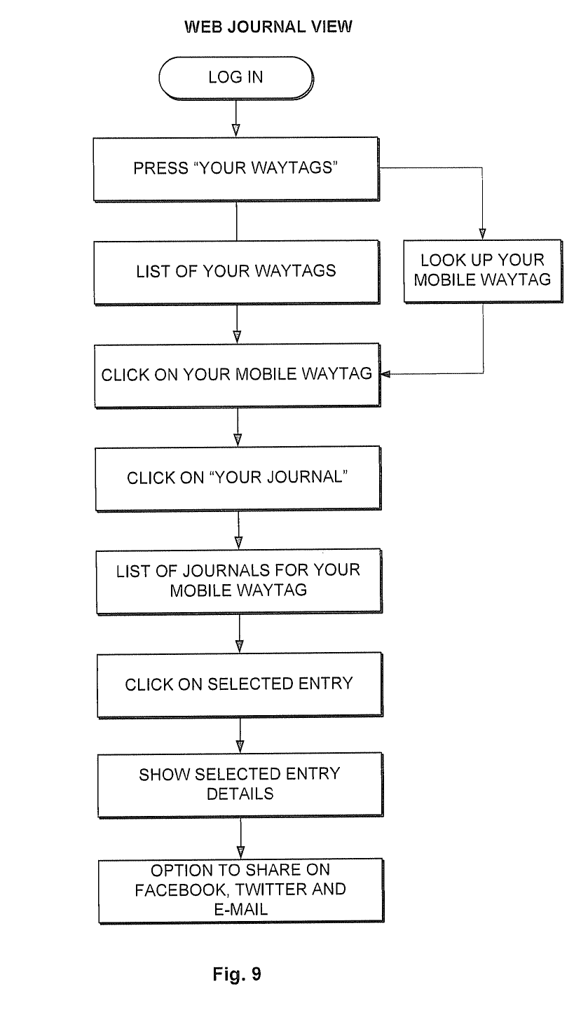

The flowchart of FIG. 9 describes the Web Journal View option offered by the system. This option allows a user 12 to log in and select the option to view their mobile Waytag, from where they may access their Journal View. In the Journal View the user 12 is able to search and view all historical journal entries and details and may share them by selecting any of the share options.

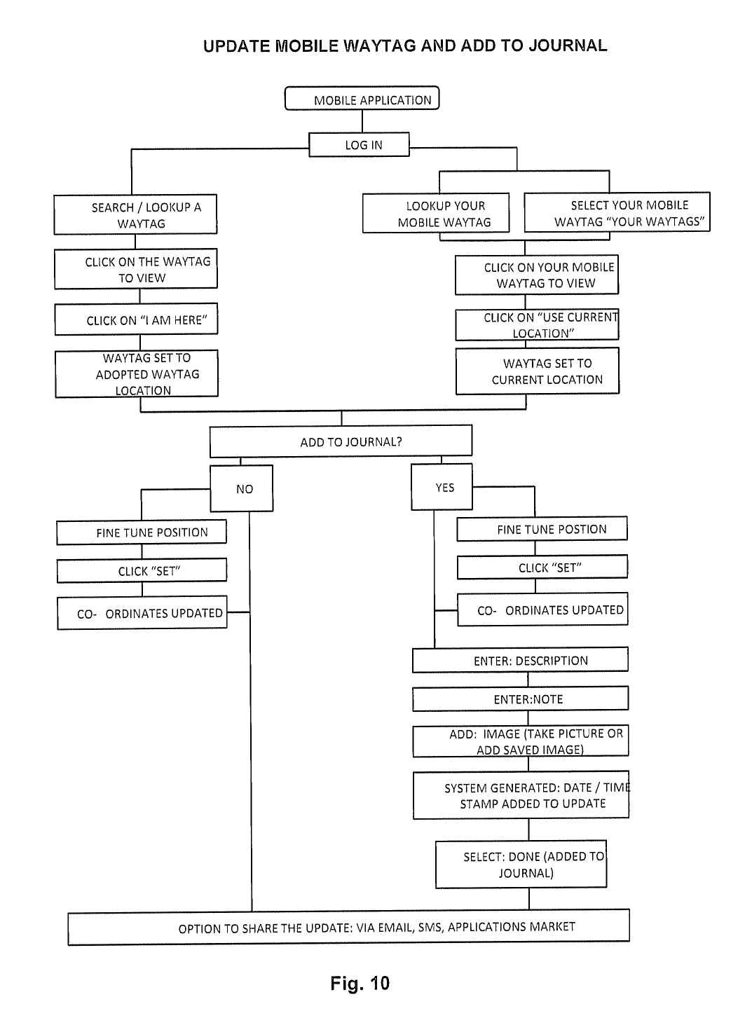

The flowchart of FIG. 10 illustrates how a user 12 can update the location of a Waytag via a mobile device 16 using the web services application 36. The location of a user may be updated by adopting the location of another Waytag by selecting “I AM HERE”, or users may update their Waytag location by selecting “USE CURRENT LOCATION”. Fine tuning of a location is catered for to remove inaccuracies associated with GPS positioning. Storing or saving the update is optional and users may elect to add the update to their journal. Journal updates allow the user to add a description, a note and an image and to share the entry. Journal updates are populated with a date and time stamp.

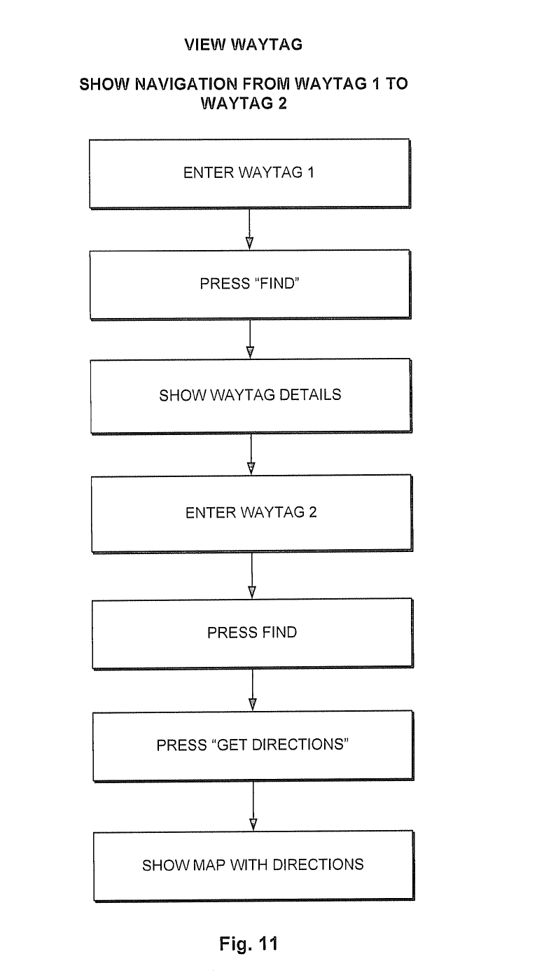

The flowchart of FIG. 11 illustrates how a user 12 may find the location of two Waytags and elect to “Get Directions” between the two Waytag locations using his/her computing device 18. It is also possible to obtain directions and navigation information from a user's current location to another Waytag using the computing device 16.

The invention as hereinbefore described provides a convenient and useful way to locate entities (as described above), people, objects, events and places. The invention also seeks to simplify the use of GPS devices, to facilitate location based marketing, to replace or complement traditional address details, postal details, delivery details and the like and to provide an internationally acceptable location identifier capable of integrating with business, social networking and other location aware services and solutions. The invention as herein described may be used by organisations such as postal services to simplify and aid in mail delivery.

1. A method of operating a location system for locating an entity, the method including:
a. receiving identification information associated with at least one entity;
b. providing a unique identifier associated with said at least one entity;
c. receiving geographic location data associated with said at least one entity; and
d. storing the received identification information, the received geographic location data and the unique identifier associated with said at least one entity in an updatable database, the unique identifier being usable to access the updatable database to retrieve the identification information and geographic location data associated with said at least one entity therefrom.

2. The method of claim 1 including receiving and storing identification data and geographic location data from a plurality of entities.

3. The method of claim 2 wherein the entities comprise people, businesses, organisations, or the like.

4. The method of claim 1 wherein the geographic location data comprises a waypoint.

5. The method of claim 4 wherein the waypoint comprises longitude and latitude co-ordinates, altitude and time, satellite positioning co-ordinates, Global Navigation Satellite Systems (GNSS) co-ordinates, or GPS (Global Positioning System) co-ordinates associated with the entity.

6. The method of claim 1 wherein the unique identifier comprises a number or numeric value, a character string, an alphanumeric code, or a combination thereof.

7. The method of claim 1 including generating the unique identifier automatically.

8. The method of claim 1 including receiving a unique identifier from a user of the location system.

9. The method of claim 1 including a step of registering the entity with the location system.

10. The method of claim 1 including the steps of:
a. receiving a unique identifier associated with a particular entity from a user;
b. accessing the database and retrieving stored identification information and geographic location data associated with a particular entity from the database using at least the received unique identifier; and
c. presenting the retrieved identification information and geographic location data to the user.

11. A location system for locating an entity, the location system including:
a. an identification receiver module arranged to receive identification information associated with at least one entity;
b. a location receiver module arranged to receive geographic location data associated with said at least one entity,
c. an updatable database arranged to store the received identification information and the received geographic location data associated with said at least one entity; and
d. an association module arranged to associate a unique identifier with said at least one entity, the unique identifier being usable to access the updatable database to retrieve the identification information and geographic location data associated with said at least one entity therefrom.

12. The location system of claim 11 including a registration module for registering said at least one entity with the location system.

13. The location system of claim 11 including a search module arranged, in response to receiving a unique identifier associated with a particular entity from a user, to access the database and retrieve stored identification information and geographic location data associated with a particular entity from the database using at least the received unique identifier, for display to the user.

14. The location system of claim 11 including a user interface supported by a web server and accessible via computing devices of users of the system to facilitate registration, receiving and storing identification data and geographic location data, updating of said identification data and geographic location data, and searching by said users.

15. The location system of claim 14 wherein the updatable database is arranged to permit the identification information and the geographic location data associated with an entity to be changed without necessarily changing the respective unique identifier associated with the entity, so that the entity may maintain the unique identifier irrespective of changes in its physical location or other identification information.
